(19) United States
(12) Patent Application Publication
(10) Pub. No.: US 2022/0216999 A1
(43) Pub. Date: Jul. 7, 2022

(54) BLOCKCHAIN SYSTEM FOR SUPPORTING CHANGE OF PLAIN TEXT DATA INCLUDED IN TRANSACTION

(71) Applicant: HYPERCERT CO., LTD., Daejeon (KR)

(72) Inventor: Yun Kyoung SUNG, Daejeon (KR)

(73) Assignee: HYPERCERT CO., LTD., Daejeon (KR)

(21) Appl. No.: 17/703,548

(22) Filed: Mar. 24, 2022

Related U.S. Application Data
(63) Continuation of application No. PCT/KR2020/011408, filed on Aug. 26, 2020.

(30) Foreign Application Priority Data
Sep. 26, 2019 (KR) 10-2019-0119057

(51) Int. Cl. H04L 9/32; H04L 9/06

(52) U.S. Cl. CPC H04L 9/3239; H04L 2209/38; H04L 9/3247; H04L 9/0618

(57) ABSTRACT

A blockchain system according to an embodiment of the present disclosure includes a generation logic, a mining logic, and a change logic. The generation logic generates a cipher-type transaction including a transaction number, a transaction type, an index, a signature for the index, an address of a sender, a cipher text, metadata, a first signature value, and a second signature value. The mining logic generates a block based on a hash function for the cipher-type transaction. The change logic receives the change transaction generated by a user based on the change plain text, and changes the transaction after verification of the change transaction is completed.

### CROSS-REFERENCE TO RELATED APPLICATIONS

The present application is a continuation of International Application No. PCT/KR2020/011408 filed on Aug. 26, 2020, which claims the benefit to Korean Patent Application No. 10-2019-0119057, filed on Sep. 26, 2019, which are incorporated herein by reference in its entirety.

### BACKGROUND

### 1. Technical Field

The present disclosure relates to a blockchain system for supporting a change of plain text data.

### 2. Related Art

In recent years, after a blockchain has been developed as a technology to provide a distribution type digital currency, various types of new blockchain technology are being studied. The blockchain technology is a technology that stores data to be managed in a distributed data storage environment called ‘block’ formed by connecting small pieces of data in a form of a linked list, and is capable of searching the data while preventing anyone from modifying the data arbitrarily, based on a P2P manner. Accordingly, the blockchain technology may provide trust in the blockchain network itself without intervention of a trusted third party. In particular, the blockchain system is a system that provides a function to ensure that data, once created, may not be changed (integrity and irreversibility), and has a high availability with P2P. Starting with Bitcoin that is the first application, Ethereum, which implemented a smart contract, has been developed, and various technologies are being grafted and studied.

The blockchain is a system that successively stores blocks from a first block in a form of a linked list, and holds blocks by synchronizing the blocks in the P2P manner for each node or client using the blockchain. A transaction or trade in the blockchain is a transaction unit between respective subjects, and verifies a validity thereof based on a public key cryptography manner.

In such a blockchain technology, it is impossible to delete data once created, which may cause great inconvenience to users depending on an application thereof. For example, in a case of blockchain-based blog service such as Steemit™, there may be a problem that created blog data which is once written may not be permanently erased. In addition, when sensitive information such as personal information is stored, there may be a problem that the sensitive information may not be permanently erased.

Therefore, depending on the application of the blockchain, there is a case of being deleted or changed, but there is no blockchain that solves this problem yet. The present disclosure intends to provide a technology related to a blockchain that may be deleted or changed as described above.

### SUMMARY

In order to solve the above problems, the present disclosure intends to provide a blockchain system that may provide a function of modifying plain text data of a transaction in which a block is generated by the blockchain system.

However, a technical object to be achieved by the present embodiment is not limited to the technical object as described above, and other technical objects may exist.

According to an embodiment of the present disclosure, there is provided a blockchain system that supports a change of plain text data included in a transaction, including: a plurality of blockchain nodes. Each of the blockchain nodes includes a communication module that transmits and receives data, a memory in which a blockchain management program is stored, and a processor that executes the blockchain program. The blockchain management program includes a generation logic for generating a plurality of transactions according to a request of each of the blockchain nodes, a mining logic for mining a block including the generated transaction, and a change logic for processing a change of a transaction.

In the embodiment described above, the generation logic may generate a cipher-type transaction including a transaction number, a transaction type, an index, a signature for the index, an address of a sender, a cipher text, metadata, and a first signature value, and a second signature value. The first signature value may be generated by encrypting the transaction type, the address of the sender, the plain text, and the metadata with the private key of the user, the second signature value is generated by encrypting the transaction type, the address of the sender, the cipher text, the metadata, and the first signature value with the private key of the user, the cipher text is encrypted by using a symmetric key encryption algorithm for the plain text. The plain text may be extracted from the cipher text by using the symmetric key decryption algorithm for the cipher text. The mining logic may generate a block based on a hash function for the cipher-type transaction, and a hash function may be applied to a value obtained by sequentially performing an exclusive OR of the index, the cipher text, the first signature value, and the second signature value, the transaction type, the address of the sender, and the metadata. The change logic may receive the change transaction generated by the user based on the change plain text, and the transaction may be changed after verification of the change transaction is completed. The change transaction may include the transaction number, the transaction type, the change index, the change index signature value, the address of the sender, the change cipher text, the metadata, the changed first signature value, and the changed second signature value. The change index may be generated by performing the exclusive OR of the index and a following third exclusive OR operation value. When a first exclusive OR operation value obtained by performing an exclusive OR of the cipher text before the change, the first signature value, and the second signature value, and a second exclusive OR operation value obtained by performing an exclusive OR of the change cipher text, the changed first signature value, and the changed second signature value are present, the third exclusive OR operation value may be an exclusive OR operation of the second exclusive OR operation value and the first exclusive OR operation value.

According to another embodiment of the present disclosure, there is provided a transaction change method performed by a blockchain system including a plurality of blockchain nodes, including: a transaction generating step of generating a cipher-type transaction including a transaction number, a transaction type, an index, a signature for the index, an address of a sender, a cipher text, metadata, a first signature value, and a second signature value. The first signature value is generated by encrypting the transaction type, the address of the sender, the plain text, and the metadata with the private key of the user. The second signature value is generated by encrypting the transaction type, the address of the sender, the cipher text, the metadata, and the first signature value with the private key of the user. The cipher text is encrypted by using a symmetric key encryption algorithm for the plain text, and the plain text is extracted from the cipher text by using the symmetric key decryption algorithm for the cipher text. In addition, the present disclosure includes a mining step of a block including the generated transaction; a step of receiving a change transaction requesting a change of the plain text for a transaction included in the mined block from a user terminal; and a step of changing the transaction after verification of the change transaction is completed.

The change transaction includes the transaction number, the transaction type, the change index, the change index signature value, the address of the sender, the change cipher text, the metadata, the changed first signature value, and the changed second signature value. The change index is generated by performing the exclusive OR of the index and a following third exclusive OR operation value. When a first exclusive OR operation value obtained by performing an exclusive OR of the cipher text before the change, the first signature value, and the second signature value, and a second exclusive OR operation value obtained by performing an exclusive OR of the change cipher text, the changed first signature value, and the changed second signature value are present, the third exclusive OR operation value is an exclusive OR operation of the second exclusive OR operation value and the first exclusive OR operation value.

According to another embodiment of the present disclosure, there is provided a blockchain system that supports a change of plain text data included in a transaction, including: a plurality of blockchain nodes. Each of the blockchain nodes includes a communication module that transmits and receives data, a memory in which a blockchain management program is stored, and a processor that executes the blockchain program. The blockchain management program includes a generation logic for generating a plurality of transactions according to a request of each of the blockchain nodes, a mining logic for mining a block including the generated transaction, and a change logic for processing a change of a transaction.

The generation logic generates a plain text transaction including a transaction number, a transaction type, an index, a signature value for the index, an address of a sender, a plain text, metadata, and a first signature value, and the first signature value is generated by encrypting the transaction type, the address of the sender, the plain text, and the metadata with the private key of the user. The mining logic generates a block based on a hash function for the plain text-type transaction, and the hash function is applied to a value obtained by sequentially performing an exclusive OR of the index, the plain text, and the first signature value, the transaction type, the address of the sender, and the metadata. The change logic receives the change transaction generated by the user based on the change plain text, and the transaction is changed after verification of the change transaction is completed. The change transaction includes the transaction number, the transaction type, the change index, the change index signature value, the address of the sender, the change plain text, the metadata, and the changed first signature value. The change index is generated by performing the exclusive OR of the index and a following third exclusive OR operation value. When a first exclusive OR operation value obtained by performing an exclusive OR of the plain text before the change and the first signature value, and a second exclusive OR operation value obtained by performing an exclusive OR of the change plain text and the changed first signature value are present, the third exclusive OR operation value is an exclusive OR operation of the second exclusive OR operation value and the first exclusive OR operation value.

According to another embodiment of the present disclosure, there is provided a transaction change method performed by a blockchain system including a plurality of blockchain nodes, including: a transaction generating step of generating a plain text-type transaction including a transaction number, a transaction type, an index, a signature for the index, an address of a sender, a plain text, metadata, and a first signature value in which the first signature value is generated by encrypting the transaction type, the address of the sender, the plain text, and the metadata with the private key of the user; a mining step of a block including the generated transaction; a step of receiving a change transaction requesting a change of the plain text for a transaction included in the mined block from a user terminal; and a step of changing the transaction after verification of the change transaction is completed.

In the blockchain system according to an embodiment of the present disclosure, it is possible to change or delete the plain text content of the transaction for the mined block. Through this, the blockchain system according to an embodiment of the present disclosure may support a case where the change or deletion processing of the plain text content of the transaction among various blockchain applications is required.

### BRIEF DESCRIPTION OF THE DRAWINGS

FIG. 1 is a diagram illustrating a configuration of a blockchain system according to an embodiment of the present disclosure;

FIG. 2 is a diagram illustrating a blockchain node according to an embodiment of the present disclosure; and

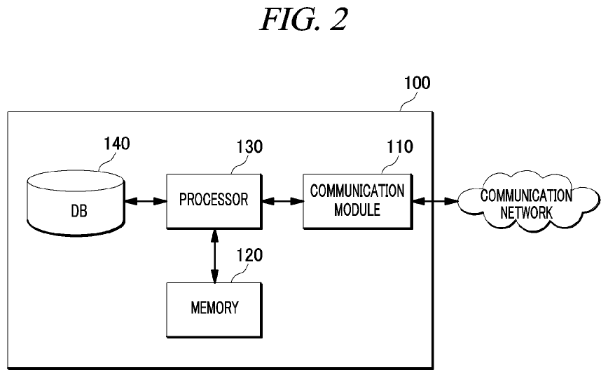

FIG. 3 is a flowchart illustrating a transaction change method according to an embodiment of the present disclosure.

### DETAILED DESCRIPTION OF THE EMBODIMENTS

Hereinafter, embodiments of the present disclosure will be described in detail so that those of ordinary skill in the art may easily carry out the present disclosure with reference to the accompanying drawings. However, the present disclosure may be embodied in several different forms and is not limited to the embodiments described herein. In addition, in order to clearly explain the present disclosure in the drawings, portions irrelevant to the description are omitted, and similar reference numerals are attached to similar portions throughout the specification.

Throughout the specification, when a portion art is “connected” to another portion art, it includes a case in which it is “directly connected” or a case where it is “electrically connected” with another element interposed therebetween. In addition, when a portion art “includes” a certain configuration element mponent, this means that another configuration element mponents may be further included, rather than excluding another configuration element mponents, unless otherwise stated.

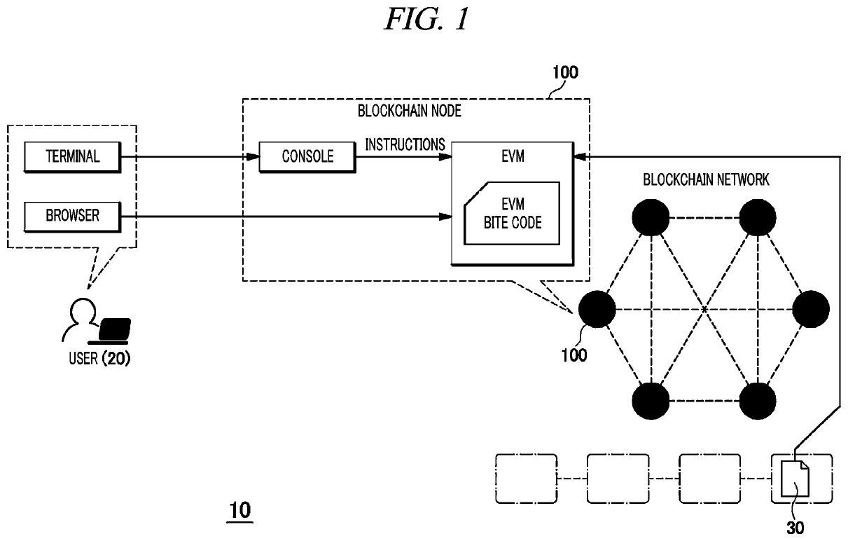

FIG. 1 illustrates a configuration of a blockchain system according to an embodiment of the present disclosure.

The blockchain system includes a plurality of blockchain nodes 100. Each blockchain node separately stores blockchain data, forms a network with each other, and maintains a synchronization state with each blockchain data. Each block included in this blockchain data stores one or more transactions. These transactions may be used to exchange cryptocurrencies, deploy smart contracts, or call functions included in the smart contracts.

A general user 20 may access the blockchain node 100 through a user terminal or browser, and may use information about transactions stored in the blockchain data or use a smart contract.

For example, an Ethereum blockchain system operates based on a virtual machine such as an EVM, and a process of generating a transaction, a process of mining a block including a plurality of transactions, a process of generating a smart contract, a process of distributing the transaction or the smart contract, a process of executing the transaction or the smart contract, or the like is are executed by the virtual machine. On the other hand, an example of the Ethereum blockchain system is presented for convenience of explanation, and the present disclosure is not limited thereto.

The smart contract is created and compiled according to a specified coding language, and as a result of the compilation, for example, an EVM byte code is generated. The smart contract generated in this way is included in each transaction, is included in the block in the process of mining the block including these transactions by the blockchain node, and is distributed to other blockchain nodes.

neural network. The search apparatus may learn the according to an embodiment of the present disclosure.

The blockchain node 100 may include a communication module 110, a memory 120, a processor 130, and a local database (DB) 140.

The communication module 110 provides a communication interface to the blockchain node 100 by interworking with a communication network, and is used to transmit and receive the blockchain data by maintaining a connection state with other blockchain nodes 100. In addition, data communication is performed with the user terminal 20 connected to the blockchain node 100. Here, the communication module 110 may be a device including hardware and software necessary for transmitting and receiving signals such as control signals or data signals through wired/wireless connection with other network devices.

A blockchain management program is stored in the memory 120. Such a blockchain management program may be implemented in a form of a virtual machine operating system that operates a plurality of blockchain nodes described above. The blockchain management program includes a generation logic that generates a plurality of transactions according to the request of each blockchain node, a mining logic that mines a block including the generated transaction, and a change logic that processes a change of the transaction.

In addition, the memory 120 may perform a function of temporarily or permanently storing data processed by the processor 130. Here, the memory 120 may include a volatile storage medium or a non-volatile storage medium, but the scope of the present disclosure is not limited thereto.

The processor 130 executes the blockchain management program to perform the generation logic for generating the transaction, the mining logic for mining the block, and the change logic for processing the change of the transaction, respectively. Here, the processor 130 may include all kinds of devices capable of processing data, such as a processor. Here, the ‘processor’ may refer to, for example, a data processing device embedded in hardware having a physically structured circuit to perform a function expressed as a code or an instruction included in a program. As an example of the data processing device embedded in the hardware as described above, a microprocessor, a central processing unit (CPU), a processor core, a multiprocessor, an application-specific integrated circuit (ASIC), a field programmable gate array (FPGA), and the like may be provided, but the scope of the present disclosure is not limited thereto.

The database 140 stores blockchain data exchanged through the blockchain network, respectively. According to characteristics of the blockchain system, the blockchain data stored in the database 140 of each blockchain node 100 is synchronized.

In the present disclosure, the principle of processing the change of the transaction is the same as a problem of finding a function such that f(a, b, c, d)=f(a′, b′, c′, d′). Here, a is a correction value, b is a cipher text, c is a signature value for a plain text, d is a signature value for the cipher texts b and c, a′ is a new correction value, b′ is a new cipher text when the plain text is changed, c′ is a signature value when the plain text is changed, and d′ is a signature value for the new cipher texts b′ and the c′.

First, the generation logic that generates the transaction may generate a plain text transaction as the following structure.

$$T N \vert T \vert A \vert B \vert P \vert Meta \vert sign ( T \vert A \vert B \vert P \vert Meta )$$

TN indicates a transaction number.

T indicates the transaction type, and in a case where when the transaction includes plain text data, a value p is recorded, and in a case where when the transaction includes encrypted data, a value e is recorded.

A indicates an address of the sender, and B indicates an address of the receiver.

P indicates the plain text, Meta indicates metadata, and may be personal information such as a social security number, remittance, data, or the like.

A sign is generated by applying a private key of the sender A to the transaction type T, the address of the sender A, the address of the receiver B, the plain text, and metadata.

When receiving the transaction described above, the blockchain node 100 verifies the signature and generates a block if there is no problem. When generating the block, a hash function such as H(T|A|B|P|Meta|S) is created and is input into a Markle tree. Here, S indicates a sign (T|A|B|P|Meta), and H indicates a cryptographically secure hash function.

In addition, the generation logic that generates the transaction may generate a cipher-type transaction with the structure below.

$$T N \vert T \vert I \vert sign ( I ) \vert A \vert E \vert Meta \vert S 1 = sign ( T \vert A \vert P \vert Meta ) \vert S 2 = sign ( T \vert A \vert E \vert Meta \vert S 1 ) \qquad$$

TN indicates a transaction number.

T indicates a type of the transaction, and in a case where if encrypted data is included, the value e is recorded.

A indicates the address of the sender of the cipher text, and B indicates the address of the receiver.

I indicates a correction value as an index. The index indicating the correction value will be described in detail later.

Sign(I) is generated by signing the index with the private key of the sender A, and is defined as an index signature value.

E is cipher text data, Meta indicates metadata, and may be the social security number, personal information, or the like.

The first signature value S1 is generated by encrypting the transaction type T, the address of the sender A, the plain text, and the metadata with the private key of the sender A. The first signature value S1 is for verification of the plain text.

The second signature value S2 is generated by encrypting the transaction type T, the address of the sender A, the cipher text, the metadata, and the first signature value S1 with the private key of the user.

When receiving the corresponding transaction, the blockchain node 100 verifies the signed index sign(I) and the second signature value S2 to check whether there is any abnormality, and creates a block if there is no abnormality.

When creating the block, the blockchain node 100 creates H(T|A∥I⊕E⊕S1⊕S2|Meta) and use it in the merkle tree. In this case, EP indicates an exclusive OR.

SK indicates the secret key, the cipher text E is the plain text encrypted by the secret key, and it indicates E=EncSK(P), and Enc indicates an encryption function of a symmetric key encryption algorithm such as AES 256.

For example, if B requests the social security number of A, the message is sent to A. When A receives the request and B is recognized as a legitimate user, it searches through a meta tag to find the corresponding transaction. When finding the transaction, A extracts the cipher text E, creates P=DecSK(E), and sends it to B. Here, Dec indicates a decryption function of a symmetric key algorithm such as AES 256.

B verifies the first signature value S1 using the P value received from A. If it is correct, it may be confirmed that the decoded value is correct.

Next, an operation of the change logic will be described.

The change logic may handle transaction change or transaction deletion in the form described below. The change logic may receive the change transaction generated by the user based on the change plain text, and change the transaction after verification of the change transaction is completed.

First, in the following cipher-type transaction, the user A wants to change the plain text P.

$$T N \vert T \vert I \vert sign ( I ) \vert A \vert E \vert Meta \vert S 1 = sign ( T \vert A \vert P \vert Meta ) \vert S 2 = sign ( T \vert A \vert E \vert Meta \vert S 1 ) \qquad$$

First, the change logic searches for the change target transaction to change and reads the value thereof.

Then, the cipher text E is decrypted by using the secret key SK, that is, the plain text P is extracted by performing DecSK(E). The user changes P to generate a change plain text P′, and then encrypts it with a secret key to generate a change cipher text E′. That is, the change cipher text E′ is generated through E′=EncSK(P′). In this case, P may be personal information or the like.

Thereafter, a changed first signature value and a changed second signature value are generated.

The changed first signature value is equal to S1′=sign(T|A|P′|Meta), and the changed second signature value is equal to S2′=sign(T|A|E′|Meta|S1′).

That is, the changed first signature value is generated by encrypting the transaction type, the address of the sender, the change plain text, and the metadata with the private key of the user, and the changed second signature value is generated by encrypting the transaction type, the address of the sender, the change cipher text, the meta data, and the changed first signature value with the private key of the user.

Then, it is assume that there are a first exclusive OR operation value D obtained by performing an exclusive OR of the cipher text before the change, the first signature value, and the second signature value, and a second exclusive OR operation value D′ obtained by performing an exclusive OR of the change cipher text, the changed first signature value, and the changed second signature value.

That is, it is assume that E⊕S1⊕S2=D, and E′⊕S1′⊕S2′=D′.

In addition, a third exclusive OR operation value D″ is obtained by performing an exclusive OR of the second exclusive OR operation value D′ and the first exclusive OR operation value D, and has the following relationship. Alternatively, the second exclusive OR operation value D′ has the same relationship as the exclusive OR operation of the first exclusive OR operation value D and the third exclusive OR operation value D″.

$${D}^{′} = D ⊕ {D}^{″} , {D}^{″} = {D}^{′} ⊕ D$$

At this time, a change the index I′ is generated by performing an exclusive OR of the index before the change and the third exclusive OR operation value D″, and the change index signature value sign(I′) is generated by encrypting it.

That is, I′=I⊕D″ and sign(I′) are generated.

Through this process, the generated change transaction has the following structure.

$$TN \vert T \vert {I}^{′} \vert sign ( {I}^{′} ) \vert A \vert {E}^{′} \vert Meta \vert S {1}^{′} = sign ( T \vert A \vert P ' \vert Meta ) \vert S {2}^{′} = sign ( T \vert A \vert E ' \vert Meta \vert S {1}^{′} )$$

That is, the change transaction is made by including the transaction number, the transaction type, the change index, the change index signature value, the address of the sender, the change cipher text, the metadata, the changed first signature value, and the changed second signature value.

The blockchain node 100 transmits the change transaction described above according to the request of the user A.

Each blockchain node 100 verifies the change index I′ and the change index signature value sign(I′). When it is sent by a legitimate user A, the changed second signature value S2′ is verified, and when the verification is completed, the corresponding transaction TN is found and the transaction is changed.

At this time, each blockchain node 100 may change the transaction without the need to create a new hash value for the changed transaction.

This is because it has a relationship of I′⊕E′⊕S1′⊕S2′=I⊕S1⊕S2. That is, this is because that the value obtained by performing the exclusive OR of the change index, the change cipher text, the changed first signature value, and the changed second signature value is equal to the value obtained by performing the exclusive OR of the index before change, the cipher text before the change, the first signature value before the change, and the second signature value before the change as described in the following formula.

Because it is I′⊕E′⊕S1′⊕S2′=I⊕D″⊕E′⊕E′⊕S1′⊕S2′=I⊕D″⊕D′ (=E′⊕S1′⊕S2′)=I⊕D″⊕D⊕D″=I⊕D=I⊕E⊕S1⊕S2.

According to this, the hash value generated when the blockchain node 100 generates the block is the same between before the plain text change and after the plain text change. That is, since H(T|A|I⊕E⊕S1⊕S2|Meta)=H(T|A|I′⊕E′⊕S1′⊕S2′|Meta), there is no need to change the hash value of the transaction and the hash value of the block.

If B requests decoding later, the same process as the decryption of the unchanged plain text is performed.

The correction value used in the present disclosure will be further described.

When describing the index I indicating representing the correction value, if the stored plain text is changed, the cipher text is also changed, and accordingly, the first signature value S1 for verifying the plain text is changed, and the second signature value S2 for verifying the cipher text and the first signature value S1 is also changed. That is, E, S1, and S2 change, and E⊕S1⊕S2 changes.

If the index I is corrected in consideration of the change, I⊕E⊕S1⊕S2 and the newly created I′⊕E′⊕S1′⊕S2′ may be made the same. That is, if a difference of E′⊕S1′⊕S2 changed from E⊕S1⊕S2 is D″, that is, it becomes E⊕S1⊕S2⊕D″=E′⊕S1′⊕S2′. If XOR is performed in I by this difference, that is, if I′=I⊕D″, then it becomes I′⊕E′⊕S1′⊕S2′=I⊕D″⊕E⊕S1⊕S2⊕D″=I⊕E⊕S1⊕S2. Therefore, the input value of the hash becomes the same. That is, the change index I′ is generated by performing the exclusive OR of the index before the change and the third exclusive OR operation value D″. Therefore, by using the change index I′, even for the transaction in which the plain text has been changed, the value input to the hash function becomes the same, so a new hash value may not be generated.

The first signature value S1 indicating the plain text digital signature value performs the following functions. The cipher text is stored in the blockchain and may be verified, but the plain text value may not be verified. Therefore, it may not be confirmed whether the plain text is an appropriately decrypted plain text or whether another hacker intercepted the plain text and changed the plain text. Accordingly, the integrity of the plain text may be verified by including the first signature value S1 for plain text verification in the transaction, and confirming whether the signature is correct with the plain text and the first signature value S1 received by the person who requested the plain text.

In addition, if the digital signature value is created on a case-by-case basis, the computation cost is added, and a problem is that if a malicious decryptor A sends another plain text instead of the plain text stored in the blockchain, digitally signs it, and sends the digital signature value to the blockchain, another plain text is received instead of the stored plain text. This may significantly undermine the features that ensure the integrity and integrity of the blockchain. Therefore, the first signature value S1 indicating the plain text digital signature value is stored in the transaction to ensure integrity, which is equivalent to performing a function such as notarization.

In addition, the second signature value S2 indicating the digital signature value for the transaction is included to prove that the corresponding transaction is made by a legitimate user.

The index signature value sign(I) that signed the index I indicating the correction value has the following functions. If the index I is changed without confirming that the index I was created by the legitimate user, anyone may access the blockchain and change the index I freely, and thereby the hash entered into the merkle tree may be broken and the blockchain may be damaged. Therefore, the index signature value is used so that only legitimate users may change the index I.

From a security point of view, it is assumed that the hacker never knows the secret key used for encryption. However, if the secret key is exposed, of course, the plain text may be recovered. In order to solve this problem, added functions are as follows.

A normal user who recognizes that the secret key has been exposed may delete or change the plain text using the present disclosure. At this time, there is a problem of whether an attacker may recover the original plain text. A hacker may recover the plain text by using the secret key if he/she has the contents of the existing transaction. However, if he/she only has the changed transaction contents, the plain text may not be recovered.

In addition, what is minimum information required to recover the existing plain text may be considered. If the existing cipher text E is provided, the decryption may be performed in any case. In a state where there is no existing cipher text E, the cipher text E may be recovered if there are the index I before the change, the first signature value S1, and the second signature value S2. The changed index I′, the changed first signature value S1′, the changed second signature value S2′, and the change cipher text E′ may be confirmed because they are stored in the blockchain.

If the index I before the change is known, D″ may be known through I⊕I′. If D″ is known, E⊕S1⊕S2 may be obtained by performing E′⊕S1′⊕S2′⊕D″. Therefore, if the first signature value S1 and the second signature value S2 are known, E may be restored through the XOR operation. Therefore, the hacker may obtain the original plain text by decrypting E with the obtained secret key.

In conclusion, if the hacker has the index I before change, the first signature value S1, and the second signature value S2, and knows the encryption secret key, even if the legitimate user changes the plain text, there is a security vulnerability that the hacker may recover the original plain text. Therefore, the encryption secret key has to be kept so as not to be exposed.

Looking at this from another point of view, when thinking of a public blockchain that anyone may access, it is a security issue that arises from recording the cipher text in the public blockchain, but by changing the plain text, if the hacker does not have any of I, S1, and S2, it also provides the security advantage of not being able to recover the original plain text.

In addition, as a modified embodiment, if the private key to be used for the signature is divided by using a known technology such as Shamir Secret Sharing, and one piece is provided to a trusted third party (such as a government agency), and the private key may be received when there is an approval from the third party, it is possible to change the transaction only in a case where when there is approval, rather than changing data arbitrarily herethrogh.

On the other hand, as a method for deleting data other than the data change, a method for changing all plain text data to a meaningless value, such as changing all to ‘0’ may be used, and accordingly, the same effect as data deletion may be expected.

As another embodiment, in the following plain text transaction, the user A wants to change the plain text P.

$$T N \vert T \vert I \vert sign ( I ) \vert A \vert B \vert P \vert Meta \vert S 1 = sign ( T \vert A \vert B \vert P \vert Meta ) \qquad$$

First, the change logic searches for the change target transaction to be changed and reads the value thereof. In addition, the plain text P is changed. The user changes P to generate the change plain text P′.

Thereafter, the changed first signature value is generated.

The changed first signature value is equal to S1′=sign(T|A|B|P′|Meta).

That is, the changed first signature value is generated by encrypting the transaction type, the address of the sender, the address of the receiver, the change plain text, and metadata with the private key of the user. In this case, the address of the receiver may be omitted.

Then, the first exclusive OR operation value D obtained by performing the exclusive OR of the plain text and the first signature value, and the second exclusive OR operation value D′ obtained by performing the exclusive OR operation of the change plain text and the changed first signature value are defined.

That is, P⊕S1=D, and P′⊕S1′=D′.

In addition, the third exclusive OR operation value D″ is obtained by performing the exclusive OR of the second exclusive OR operation value D′ and the first exclusive OR operation value D, and has the following relationship. Alternatively, the second exclusive OR operation value D′ has the same relationship as the exclusive OR operation of the first exclusive OR operation value D and the third exclusive OR operation value D″.

$${D}^{′} = D ⊕ {D}^{″} , {D}^{″} = {D}^{′} ⊕ D$$

Then, the change index I′ is generated by performing the exclusive OR of the index before the change and the third exclusive OR operation value D″, and the change index signature value sign(I′) is generated by encrypting it.

That is, I′=I⊕D″ and sign(I′) are generated.

Through this process, the generated change transaction has the following structure.

TN|T|I′|sign(I′)|A|B|P′|Meta|S1′=sign (T|A|B|P′|Meta) is created.

That is, the change transaction includes the transaction number, the transaction type, the change index, the change index signature value, the address of the sender, the change cipher text, the metadata, and the changed first signature value. In this case, the address of the receiver B may be omitted.

The blockchain node 100 transmits the change transaction described above according to the request of the user A. Each blockchain node 100 verifies the change index I′ and the change index signature value sign(I′). If it is sent by the legitimate user A, the changed first signature value (S21) is verified, and when the verification is completed, the corresponding transaction TN is found and the transaction is changed.

At this time, each blockchain node 100 may change the transaction without the need to create a new hash value for the changed transaction.

This is because that a relationship of I′⊕P′⊕S1′=I⊕P⊕S1 is provided. That is, this is because that the value obtained by performing the exclusive OR of the change index, the change plain text, and the changed first signature value is the same as the value obtained by performing the exclusive OR of the index before the change, the plain text before the change, and the first signature value before the change, as described in the formula below.

$${I}^{′} ⊕ {P}^{′} ⊕ S {1}^{′} = I ⊕ {D}^{″} ⊕ {D}^{′} ( = {P}^{′} ⊕ S {1}^{′} ) = I ⊕ {D}^{″} ⊕ {D}^{′} ( = D ⊕ {D}^{″} ) = I ⊕ D = I ⊕ P ⊕ S 1 \qquad$$

According to this, the hash value generated when the blockchain node 100 generates the block is the same before the plain text is changed and after the plain text is changed. That is, since H(T|A|B|I⊕P⊕S1|Meta)=H(T|A|B|I′⊕P′⊕S1′|Meta), there is no need to change the hash value of the transaction and the hash value of the block. In this case, the address of the receiver B may be omitted.

In the description of the index I indicating the correction value, if the stored plain text is changed, the first signature value S1 for verifying the plain text is changed, and thus P⊕S1 is changed.

If the index I is corrected in consideration of the change amount, a relationship of I′⊕P′⊕S1′=I⊕P⊕S1 may be obtained. That is, if the difference between P⊕S1 and changed P′⊕S1′ is D″, that is, P⊕S1⊕D″=P′⊕S1′ is provided. If the XOR is formed in I by this difference, that is, if I′=I⊕D″, then I′⊕P′⊕S1′=I⊕D″⊕P′⊕S1′=I⊕D″⊕P⊕S1⊕D″=I⊕P⊕S1 is provided. Therefore, the input value of the hash becomes the same. That is, the change index I′ is generated by performing the exclusive OR of the index before the change and the third exclusive OR operation value D″, and by using this, the value input to the hash function becomes the same even for the transaction in which the plain text has been changed. Therefore, a new hash value may not be generated.

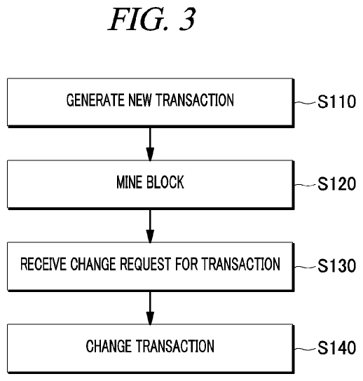

FIG. 3 is a flowchart illustrating a transaction change method in the blockchain system according to an embodiment of the present disclosure.

First, a cipher-type transaction or a plain text transaction is generated (S110). As described above, the cipher-type transaction includes the transaction number, the transaction type, the index, the signature for the index, the address of the sender, the cipher text, the metadata, the first signature value, and the second signature value. In this case, the first signature value means that is generated by encrypting the transaction type, the address of the sender, the plain text, and the metadata with the private key of the user, and the second signature value means that is generated by encrypting the transaction type, the address of the sender, the cipher text, the metadata, and the first signature value with the private key of the user. On the other hand, the cipher text is obtained by encrypting the plain text by using the symmetric key encryption algorithm, and the plain text may be extracted from the cipher text by using the symmetric key decryption algorithm for the cipher text.

In addition, the plain text transaction includes the transaction number, the transaction type, the index, the signature value for the index, the address of the sender, the plain text, the metadata, and the first signature value. In this case, the first signature value is generated by encrypting the transaction type, the address of the sender, the plain text, and the metadata with the private key of the user.

Next, a block including the generated transaction is mined (S120).

The specific method for block mining may be different depending on the blockchain system, and since it corresponds to the specific prior art, a detailed description thereof will be omitted.

Next, the change transaction requesting the change of the plain text for the transaction included in the mined block is received from the user terminal (S130).

At this time, the change transaction of the cipher-type transaction includes the transaction number, the transaction type, the change index, the change index signature value, the address of the sender, the change cipher text, the metadata, the changed first signature value, and the changed second signature value.

First, the first exclusive OR operation value D obtained by performing the exclusive OR of the cipher text before the change, the first signature value, and the second signature value, and the second the exclusive OR operation value D′ obtained by performing the exclusive OR of the change cipher text, the changed first signature value, and the changed second signature value are prepared. At this time, the third exclusive OR operation value D″ is obtained by performing the exclusive OR of the second exclusive OR operation value and the first exclusive OR operation value.

When a request to change the transaction is received in this way, as described above, the value obtained by sequentially performing the exclusive OR operation of the index, the cipher text, the first signature value, and the second signature value input to the hash function is the same as the value obtained by sequentially performing the exclusive OR operation of the change index, the change cipher text, the changed first signature value, and the changed second signature value. Therefore, the hash value does not change. Accordingly, the mined block is not changed.

In addition, the change transaction of the plain text transaction includes the transaction number, the transaction type, the change index, the change index signature value, the address of the sender, the change plain text, the metadata, and the changed first signature value.

First, when there are the first exclusive OR operation value D obtained by performing the exclusive OR of the plain text and the first signature value before the change, and the second exclusive OR operation value D′ obtained by performing the exclusive OR of the change plain text and the changed first signature value, the third exclusive OR operation value D″ is obtained by performing the exclusive OR of the second exclusive OR operation value D′ and the first exclusive OR operation value D. In addition, the change index is generated by performing the exclusive OR of the index and the third exclusive OR operation value D″.

When the change of the transaction is normally performed by the legitimate user, the value obtained by sequentially performing the exclusive OR operation of the index, the plain text, and the first signature value input to the hash function is the same as the value obtained by sequentially performing the exclusive OR operation of the change index, the change plain text, and the changed first signature value. Therefore, the hash value does not change. Accordingly, the mined block is not changed.

On the other hand, a method for changing plain text data in a blockchain system according to an embodiment of the present disclosure may be implemented in a form of a recording medium including instructions executable by a computer, such as a program module executed by a computer. Computer-readable media may be any available media that may be accessed by a computer and includes all of volatile and nonvolatile media, and removable and non-removable media. In addition, the computer-readable media may include computer storage media. Computer storage media includes all of volatile and nonvolatile, and removable and non-removable media implemented by any method or technology for storage of information such as computer readable instructions, data structures, program modules, or other data. Although the method and the system of the present disclosure have been described with reference to specific embodiments, some or all of their configuration elements or operations may be implemented by using a computer system having a general purpose hardware architecture.

The above description is merely illustrative of the technical idea of the present disclosure, and various modifications and variations will be possible without departing from the essential characteristics of the present disclosure by those skilled in the art to which the present disclosure pertains.

Accordingly, the embodiments disclosed in the present disclosure are not intended to limit the technical spirit of the present disclosure, but to explain the technical spirit of the present disclosure, and the scope of the technical spirit of the present disclosure is not limited by these embodiments. The protection scope of the present disclosure should be interpreted by the following claims, and all technical ideas within the scope equivalent thereto should be construed as being included in the scope of the present disclosure.

What is claimed is:

1. A blockchain system that supports a change of plain text data included in a transaction, comprising:
a plurality of blockchain nodes,
wherein each of the blockchain nodes includes a communication module that transmits and receives data, a memory in which a blockchain management program is stored, and a processor that executes the blockchain program,
wherein the blockchain management program includes a generation logic for generating a plurality of transactions according to a request of each of the blockchain nodes, a mining logic for mining a block including the generated transaction, and a change logic for processing a change of a transaction,
wherein the generation logic generates a cipher-type transaction including a transaction number, a transaction type, an index, a signature for the index, an address of a sender, a cipher text, metadata, a first signature value, and a second signature value,
wherein the first signature value is generated by encrypting the transaction type, the address of the sender, the plain text, and the metadata with the private key of the user, the second signature value is generated by encrypting the transaction type, the address of the sender, the cipher text, the metadata, and the first signature value with the private key of the user, the cipher text is encrypted by using a symmetric key encryption algorithm for the plain text, and the plain text is extracted from the cipher text by using the symmetric key decryption algorithm for the cipher text,
wherein the mining logic generates a block based on a hash function for the cipher-type transaction, and a hash function is applied to a value obtained by sequentially performing an exclusive OR of the index, the cipher text, the first signature value, and the second signature value, the transaction type, the address of the sender, and the metadata,
wherein the change logic receives the change transaction generated by the user based on the change plain text, and the transaction is changed after verification of the change transaction is completed,
wherein the change transaction includes the transaction number, the transaction type, the change index, the change index signature value, the address of the sender, the change cipher text, the metadata, the changed first signature value, and the changed second signature value, and the change index is generated by performing the exclusive OR of the index and a following third exclusive OR operation value, and
wherein when a first exclusive OR operation value obtained by performing an exclusive OR of the cipher text before the change, the first signature value, and the second signature value, and a second exclusive OR operation value obtained by performing an exclusive OR of the change cipher text, the changed first signature value, and the changed second signature value are present, the third exclusive OR operation value is an exclusive OR operation of the second exclusive OR operation value and the first exclusive OR operation value.

2. The blockchain system of claim 1,
wherein the change logic verifies whether the change index and the change index signature value included in the change transaction are transmitted by the user, performs verification on the second signature value after the verification is completed, and performs the change of the transaction after the verification is completed.

3. The blockchain system of claim 1,
wherein when the change of the transaction is normally performed by a legitimate user, the value obtained by sequentially performing the exclusive OR operation of the index, the cipher text, the first signature value, and the second signature value input to the hash function is the same as the value obtained by sequentially performing the exclusive OR operation of the change index, the change cipher text, the changed first signature value, and the changed second signature value.

4. A transaction change method performed by a blockchain system including a plurality of blockchain nodes, comprising:
a transaction generating step of generating a cipher-type transaction including a transaction number, a transaction type, an index, a signature for the index, an address of a sender, a cipher text, metadata, a first signature value, and a second signature value;
a mining step of a block including the generated transaction;
a step of receiving a change transaction requesting a change of the plain text for a transaction included in the mined block from a user terminal; and
a step of changing the transaction after verification of the change transaction is completed,
wherein the first signature value is generated by encrypting the transaction type, the address of the sender, the plain text, and the metadata with the private key of the user, the second signature value is generated by encrypting the transaction type, the address of the sender, the cipher text, the metadata, and the first signature value with the private key of the user, the cipher text is encrypted by using a symmetric key encryption algorithm for the plain text, and the plain text is extracted from the cipher text by using the symmetric key decryption algorithm for the cipher text,
wherein the change transaction includes the transaction number, the transaction type, the change index, the change index signature value, the address of the sender, the change cipher text, the metadata, the changed first signature value, and the changed second signature value,
wherein the change index is generated by performing the exclusive OR of the index and a following third exclusive OR operation value, and
wherein when a first exclusive OR operation value obtained by performing an exclusive OR of the cipher text before the change, the first signature value, and the second signature value, and a second exclusive OR operation value obtained by performing an exclusive OR of the change cipher text, the changed first signature value, and the changed second signature value are present, the third exclusive OR operation value is an exclusive OR operation of the second exclusive OR operation value and the first exclusive OR operation value.

5. The transaction change method of claim 4,
wherein the step of changing the transaction verifies whether the change index and the change index signature value included in the change transaction are transmitted by the user, performs verification on the second signature value after the verification is completed, and performs the change of the transaction after the verification is completed.

6. The transaction change method of claim 4,
wherein when the change of the transaction is normally performed by a legitimate user, the value obtained by sequentially performing the exclusive OR operation of the index, the cipher text, the first signature value, and the second signature value input to the hash function is the same as the value obtained by sequentially performing the exclusive OR operation of the change index, the change cipher text, the changed first signature value, and the changed second signature value.

7. A blockchain system that supports a change of plain text data included in a transaction, comprising:
a plurality of blockchain nodes,
wherein each of the blockchain nodes includes a communication module that transmits and receives data, a memory in which a blockchain management program is stored, and a processor that executes the blockchain program,
wherein the blockchain management program includes a generation logic for generating a plurality of transactions according to a request of each of the blockchain nodes, a mining logic for mining a block including the generated transaction, and a change logic for processing a change of a transaction,
wherein the generation logic generates a plain text transaction including a transaction number, a transaction type, an index, a signature value for the index, an address of a sender, a plain text, metadata, and a first signature value, and the first signature value is generated by encrypting the transaction type, the address of the sender, the plain text, and the metadata with the private key of the user,
wherein the mining logic generates a block based on a hash function for the plain text-type transaction, and the hash function is applied to a value obtained by sequentially performing an exclusive OR of the index, the plain text, and the first signature value, the transaction type, the address of the sender, and the metadata,
wherein the change logic receives the change transaction generated by the user based on the change plain text, and the transaction is changed after verification of the change transaction is completed,
wherein the change transaction includes the transaction number, the transaction type, the change index, the change index signature value, the address of the sender, the change plain text, the metadata, and the changed first signature value,
wherein the change index is generated by performing the exclusive OR of the index and a following third exclusive OR operation value, and
wherein when a first exclusive OR operation value obtained by performing an exclusive OR of the plain text before the change and the first signature value, and a second exclusive OR operation value obtained by performing an exclusive OR of the change plain text and the changed first signature value are present, the third exclusive OR operation value is an exclusive OR operation of the second exclusive OR operation value and the first exclusive OR operation value.

8. The transaction change method of claim 7,
wherein the step of changing the transaction verifies whether the change index and the change index signature value included in the change transaction are transmitted by the user, performs verification on the second signature value after the verification is completed, and performs the change of the transaction after the verification is completed.

9. The transaction change method of claim 7,
wherein when the change of the transaction is normally performed by a legitimate user, the value obtained by sequentially performing the exclusive OR operation of the index, the plain text, and the first signature value, input to the hash function is the same as the value obtained by sequentially performing the exclusive OR operation of the change index, the change plain text, and the changed first signature value.

10. A transaction change method performed by a blockchain system including a plurality of blockchain nodes, comprising:
a transaction generating step of generating a plain text-type transaction including a transaction number, a transaction type, an index, a signature for the index, an address of a sender, a plain text, metadata, and a first signature value in which the first signature value is generated by encrypting the transaction type, the address of the sender, the plain text, and the metadata with the private key of the user;
a mining step of a block including the generated transaction;
a step of receiving a change transaction requesting a change of the plain text for a transaction included in the mined block from a user terminal; and
a step of changing the transaction after verification of the change transaction is completed,
wherein the change transaction includes the transaction number, the transaction type, the change index, the change index signature value, the address of the sender, the change plain text, the metadata, and the changed first signature value,
wherein the change index is generated by performing the exclusive OR of the index and a following third exclusive OR operation value, and
wherein when a first exclusive OR operation value obtained by performing an exclusive OR of the plain text before the change and the first signature value, and a second exclusive OR operation value obtained by performing an exclusive OR of the change plain text and the changed first signature value are present, the third exclusive OR operation value is an exclusive OR operation of the second exclusive OR operation value and the first exclusive OR operation value.

11. The transaction change method of claim 10,
wherein the step of changing the transaction verifies whether the change index and the change index signature value included in the change transaction are transmitted by the user, performs verification on the second signature value after the verification is completed, and performs the change of the transaction after the verification is completed.

12. The transaction change method of claim 10,
wherein when the change of the transaction is normally performed by a legitimate user, the value obtained by sequentially performing the exclusive OR operation of the index, the plain text, and the first signature value input to the hash function is the same as the value obtained by sequentially performing the exclusive OR operation of the change index, the change plain text, and the changed first signature value.
